(19) United States
(12) Patent Application Publication
(10) Pub. No.: US 2020/0199933 A1
(43) Pub. Date: Jun. 25, 2020

(54) LOWER MASS FRAME COMPONENT WITH CLIMATE RESISTANT CHARACTERISTICS

(71) Applicant: Engineered Profiles LLC, Columbus, OH (US)

(72) Inventors: Vickram DHANAPAL, Delaware, OH (US); Troy KIMMES, Johnstown, OH (US); Robert Anthony OPST, Hillsboro, OH (US); Matthew Thomas FENNEMAN, Columbus, OH (US)

(21) Appl. No.: 16/230,285

(22) Filed: Dec. 21, 2018

(51) Int. Cl. E06B 3/96; E06B 7/14; E06B 3/22; E06B 1/70; E06B 3/20

(52) U.S. Cl. CPC E06B 3/9632; E06B 7/14; E06B 3/205; E06B 1/70; E06B 3/22

(57) ABSTRACT

A component adapted to form a portion of a frame (e.g., a sill), door, trim piece, or the like. The component having a body comprised of at least one interior hollow portion that forms an opening at a first end of body, wherein the at least one interior hollow portion has a closed end such that water is prevented from traveling from a second end through the at least one interior hollow portion to the first end. A related method of manufacturing the component such as by injection molding, 3D printing, or multi-step extrusion is also provided.

### BACKGROUND AND SUMMARY OF THE INVENTION

Exemplary embodiments of the present invention relate generally to a component to be joined to a frame or door to prevent or limit rot.

Wooden doors and frames are susceptible to rot. Typically, rot eventually appears near the bottom of a frame or door as water (e.g., rainwater) collects or splashes against it or condensation develops on it. The rot often necessitates replacement of the damaged area or even the entire frame or door.

One solution to combat wood rot is to use a different material. For instance, some doors or frames may primarily be made of wood with an end cap at the bottom being a rot-resistant material. These end caps may be made from extruded wood-plastic composite. A wood-plastic composite may resist rot and provide a similar look and feel as wood, especially once painted or stained. However, the use of a wood-plastic composite comes with initial added cost over traditional wood.

The cost associated with the use of an extruded wood composite is further compounded by the typical solid shape of the component. In fact, extrusion requires the same cross-sectional shape along the length of the component. The resulting solid shape therefore requires more material, which drives up the cost.

In view of the shortcomings of the known art, there is a need for an improved component for resisting rot of a frame, door, trim piece, or the like. There is a further need for an improved process for making a component that resists rot of a frame, door, trim piece, or the like. There is also a further need for reducing the amount of material required to manufacture a component that resists rot of a frame or door.

An exemplary embodiment may satisfy one or more of the aforementioned needs. One exemplary embodiment of the present invention is a component that is adapted to form a portion of a frame, door, trim piece, or the like. In a preferred embodiment, the component may be made with a wood-plastic composite or other rot-resistant material. However, other embodiments may be made with other materials. An exemplary embodiment of the component may have a body comprised of at least one hollow portion, which may help to reduce material cost. In addition, the at least one interior hollow portion may have a closed end (e.g., top or bottom) such that water is prevented from traveling from one end of the body through the at least one interior hollow portion to another end of the body. For example, after one type of installation, such a configuration may prevent water at ground level from wicking or otherwise travelling up through the at least one interior hollow portion, which may help to prevent or limit rotting or other water damage to the frame (e.g., sill), door, trim piece, or the like to which the component is attached or is otherwise used.

Another embodiment of the present invention relates to a method of manufacturing the aforementioned component. In particular, in an exemplary embodiment, the component may be manufactured by any suitable manufacturing process that facilitates the formation of the aforementioned hollow portion(s) in the component. For instance, examples of suitable manufacturing processes may include, but are not limited to, injection molding, 3D printing, and multi-step extrusion (such as by joining two or more sections to form a final component. Such manufacturing processes may therefore facilitate a reduction in material cost in comparison to a solid product (which is similar except for the absence of the at least one hollow portion) such as may be made by extrusion.

In addition to the novel features and advantages mentioned above, other benefits will be readily apparent from the following descriptions of the drawings and exemplary embodiments.

### BRIEF DESCRIPTION OF THE DRAWINGS

FIG. 1 is a perspective view of an exemplary embodiment of a component of the present invention.

FIG. 2 is a perspective view of the component of FIG. 1.

FIG. 3 is a front elevation view of the component of FIG. 1, which indicates a cross-section line 7-7.

FIG. 4 is a rear elevation view of the component of FIG. 1.

FIG. 5 is a side elevation view of the component of FIG. 1.

FIG. 6 is a side elevation view of the component of FIG. 1.

FIG. 7 is a cross-sectional view of the component of FIG. 3.

FIG. 8 is a bottom plan view of the component of FIG. 1.

FIG. 9 is a perspective view of the component of FIG. 1.

FIG. 10 is a perspective view of a second exemplary embodiment of a component of the present invention.

FIG. 11 is a cross-sectional view of a third exemplary embodiment of a component of the present invention, which further illustrates a possible use of a fastener in association with the component such as for connecting to or otherwise forming a portion of a door sill.

### DETAILED DESCRIPTION OF EXEMPLARY EMBODIMENT(S)

Exemplary embodiments of the present invention are directed to a component for forming a portion of frame, door, trim piece, or the like. Exemplary embodiments also include a method for manufacturing such a component.

An exemplary embodiment of the component may be used to form an original portion of a frame, door, trim piece, or the like. Alternatively, an exemplary embodiment of a component may be used to replace a damaged portion of a frame, door, trim piece, or the like. For instance, if a portion of a frame, door, trim piece, or the like is rotting or has other water damage, the damaged portion may be removed and replaced with an exemplary embodiment of a component of the present invention.

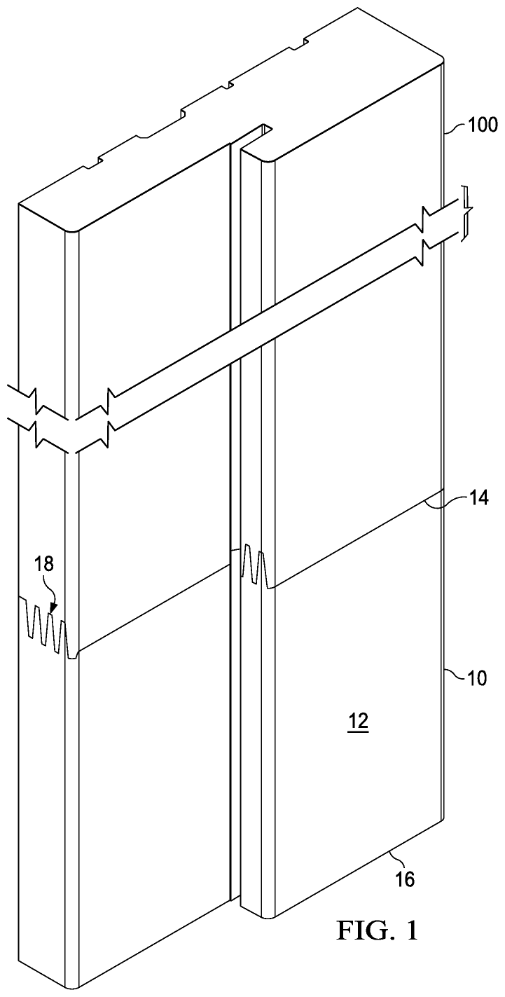

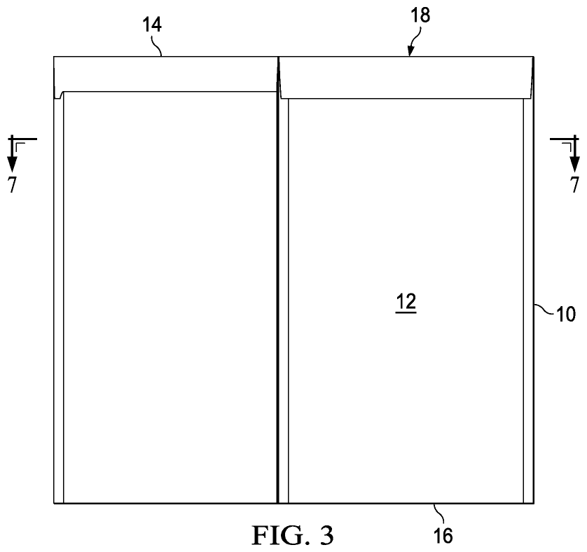

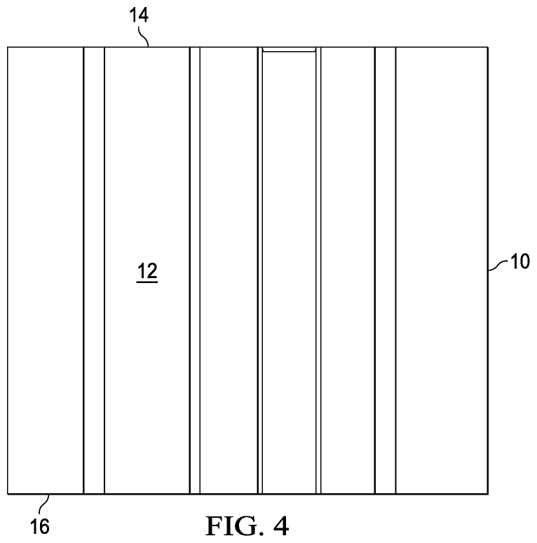

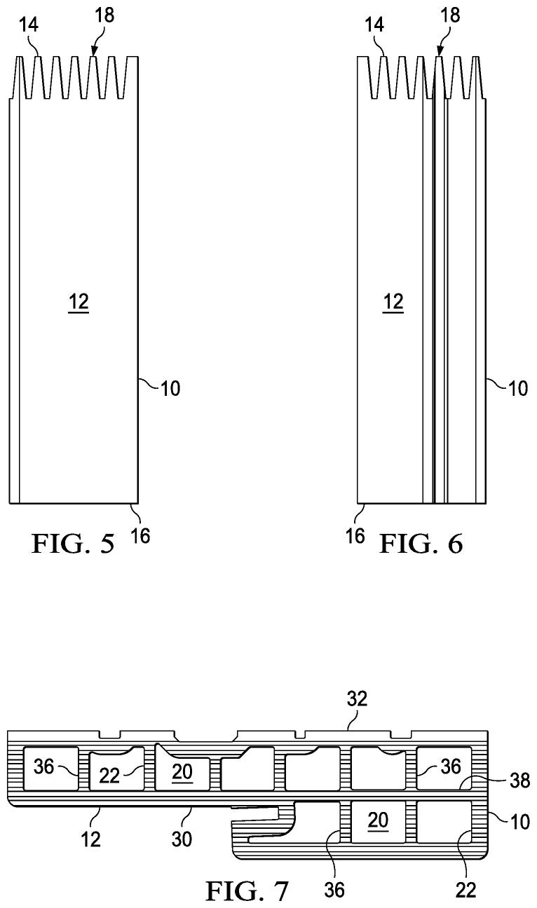

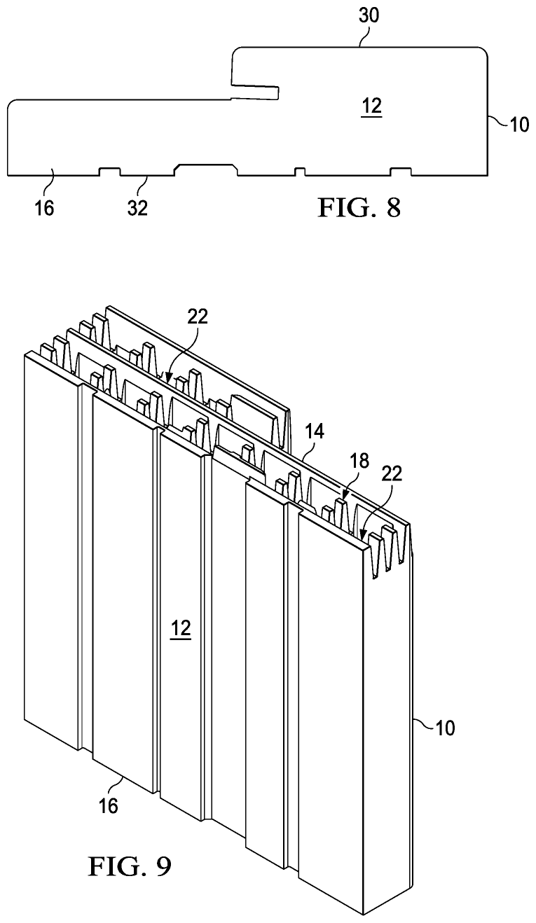

FIGS. 1-9 show an exemplary embodiment of a component 10 that is connected to a frame member 100. Component 10 may be connected to frame member 100 in any suitable manner. For instance, adhesives, mechanical fasteners, or other suitable means for connecting wood, metal, plastic, or composite components may be used. While this is an example of a framing use, the same connection principles apply for other framing, door, trim piece, or the like, uses. Furthermore, for other uses, an exemplary component may have any suitable exterior appearance for the intended use of the component.

In particular, an exemplary embodiment of a component 10 is comprised of a body 12 that may have a suitable shape for use with a door, frame, trim piece, or the like. In this exemplary embodiment, the body 12 has a first end 14 and a second end 16. Such as shown in FIG. 1, first end 14 is adapted to be connected to a portion of a frame, door, trim piece, or the like (e.g., frame member 100). In this example, first end 14 forms a finger joint 18 (herein, finger joint shall be understood to mean one side of a finger joint, unless otherwise specified). Finger joint 18 may be formed during the original manufacturing of component 10, or may be subsequently formed in component 10 by a machining process. In other embodiments, a first end may have any other suitable shape to facilitate connection to a portion of a frame, door, trim piece, or the like. On the other hand, second end 16 is substantially flat in this exemplary embodiment. In other embodiments, a second end may have any suitable shape, including but not limited to a shape to facilitate connection to another component.

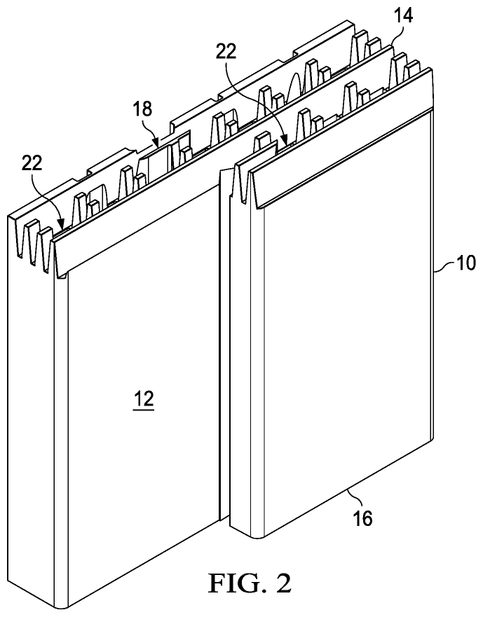

As most clearly shown in FIG. 7, body 12 is comprised of at least one interior hollow portion 20 that forms an opening 22 at first end 14, such as where generally indicated in FIGS. 2 and 9. Thus, in this example, the openings 22 extend up through finger joint 18. The cross-sectional view of FIG. 7 shows openings 22 extending below first end 14. Such as can be seen in the example of FIG. 7, the interior hollow portions 20 occupy an entire cross-sectional area of first end 14, which facilitates a reduction in the amount of material required to make component 10 as compared to a solid component. In other embodiments, the at least one interior hollow portion may be positioned differently or less throughout a cross-sectional area of body 12, yet may still facilitate a reduction in the amount of material required to make component 10 as compared to a solid component.

More particularly, in this exemplary embodiment, the at least one interior hollow portion 20 extends between lateral sides 30 and 32 of body 12, wherein lateral sides 30 and 32 extend between first end 14 and second end 16. As can be seen in FIG. 7, the hollow portions 20 extend in a direction parallel to lateral sides 30 and 32. The body 12 further comprises at least one transverse member 36 that extends between lateral sides 30 and 32 to form at least one interior hollow portion 20, as well as stabilize the sides of body 12. In addition, at least one dividing member 38 may extend through at least one transverse member 36 to further stabilize body 12 and facilitate the formation of at least one additional interior hollow portion 20. In other embodiments, an interior hollow portion may extend in another direction relative to the sides of the body. Additionally, in other embodiments, a body may be comprised of any number of transverse or dividing members, or may not include any transverse or dividing members.

In this example, each interior hollow portion 20 further has at least one closed end (e.g., a bottom and/or top) that is closed such that water is prevented from wicking or otherwise traveling from the second end 16 through an interior hollow portion 20 to first end 14. More particularly, in this example, the bottoms of the interior hollow portions 20 are at second end 16 such that the bottoms are interconnected to form the substantially flat bottom surface at second end 16. In another embodiment, the tops of the interior hollow portions may be interconnected to form a substantially flat top surface of a component. Also, in another exemplary embodiment, the bottom or top of at least one interior hollow portion may be positioned intermediately between first end 14 and second end 16. Also, in other embodiments, the closed ends (e.g., bottoms or tops) may be positioned at different levels, if desired.

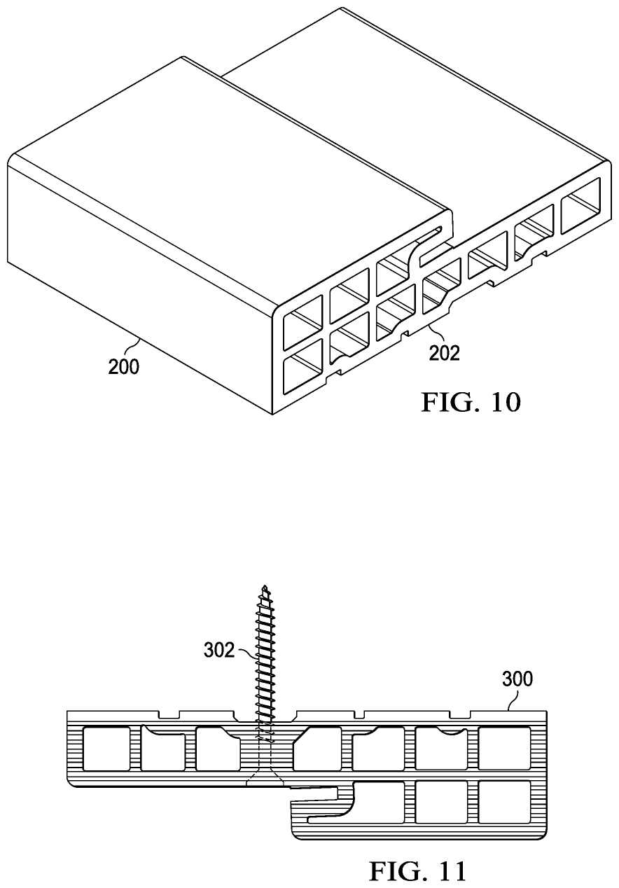

FIG. 10 shows another exemplary embodiment of a component 200 of the present invention. Component 200 may be similar to component 10, with the exception that component 200 has a first end 202 that is substantially flat. This exemplary embodiment of component 200 may be used as is to be connected to a frame, door, trim piece, or the like. In particular, similar to component 10, component 200 may be connected to another component such as with adhesives, mechanical fasteners, or other suitable means for connecting wood, metal, plastic, or composite components.

Component 200 may also be post-processed to facilitate connection to a frame, door, trim piece, or the like. Such as mentioned with respect to component 10, component 200 may be initially formed as shown in FIG. 10, and then may be later subjected to a machining process to facilitate the formation of a desired joint or other shape at first end 202. For example, component 200 may be machined to form finger joint 18 of component 10. Any suitable machining process may be used for the type of material from which component 200 is made. In one example, conventional wood processing equipment (such as for making frames, doors, trim pieces, or the like) may be used to further form component 200 (not limited to first end 202) into a desired joint or other shape.

FIG. 11 illustrates yet another embodiment of a component 300 of the present invention. Component 300 may be similar to components 10 and 200, with the exception of a different configuration for further facilitating one desired use of a fastener 302 (e.g., such as for securing component 300 to a support structure). Fastener 302 may also be inserted in an opposite direction through component 300, if desired. Component 300 may include a receptacle that is pre-formed to facilitate a desired use of a fastener, or a fastener may simply be used with a component without any pre-formed receptacles. In other embodiments, other types of mechanical fasteners, adhesives, or other suitable means for connecting wood, metal, plastic, or composite components may be used to secure a component of the present invention to a support structure (e.g., a wall, door sill, foundation, frame, etc.).

In light of the at least one hollow portion having a closed end, preferred methods of manufacturing may include injection molding, 3D printing, and multi-step extrusion. Such manufacturing processes may facilitate the formation of the closed end(s) of the at least one interior hollow portion. In some exemplary embodiments, injection molding may also facilitate the formation of a finger joint (e.g., finger joint 18) or other type of joint, shape, or aesthetic feature. However, unless otherwise specified, other suitable types of manufacturing may be used to manufacture a component of the present invention. For instance, in the event that an exemplary component of the present invention is not made from a material that is amenable to injection molding, another suitable type of manufacturing may be implemented to make the exemplary component.

As aforementioned, an exemplary component of the present invention is preferably manufactured from a rot-resistant material. For example, an exemplary embodiment of a component may be comprised of plastic, plastic composite, metal, or another rot-resistant material. In some preferred embodiments, a plastic or plastic composite may be utilized, which may facilitate manufacturing by injection molding. In such instances, any suitable type of plastic (e.g., polymer) may be used. Examples of polymer may include, but are not limited to, polyvinyl chloride (PVC), polyethylene, and polypropylene. Examples of fillers for a plastic composite may include, but are not limited to, organic fillers (e.g., cellulosic filler and other plant matter) and inorganic fillers (e.g., glass, inorganic fibers, and minerals). Other additives may be implemented. However, unless otherwise specified, a component of the present invention may be made from any suitable material, including materials that may not be rot-resistant.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A component adapted to form a portion of a frame, door, trim piece, or the like, said component comprising:
a body having a first end and a second end, said body comprised of at least one interior hollow portion that forms an opening at said first end of body, said at least one interior hollow portion having a closed end such that water is prevented from traveling from said second end through said at least one interior hollow portion to said first end.

2. The component of claim 1 wherein said first end is adapted to be connected to another structure.

3. The component of claim 1 wherein said first end forms a finger joint.

4. The component of claim 1 wherein said closed end of said at least one interior hollow portion is at said second end.

5. The component of claim 1 wherein said closed end of said at least one interior hollow portion is positioned intermediately between said first end and said second end.

6. The component of claim 1 wherein:
said body has lateral sides that extend between said first end and said second end; and
said at least one interior hollow portion extends in a direction parallel to said lateral sides.

7. The component of claim 1 wherein said body is comprised of a plurality of said interior hollow portions.

8. The component of claim 7 wherein said interior hollow portions occupy an entire cross-sectional area of said first end.

9. The component of claim 7 wherein said closed ends of said interior hollow portions are interconnected to form a substantially flat bottom surface at said second end.

10. The component of claim 7 wherein said body comprises:
lateral sides that extend between said first end and said second end; and
transverse members that extend between said lateral sides to form said interior hollow portions.

11. The component of claim 10 wherein said interior hollow portions extend in a direction parallel to said lateral sides.

12. A method for manufacturing a component adapted to form a portion of a frame, door, trim piece, or the like, said method comprising:
injection molding a body having a first end and a second end, said body comprised of at least one interior hollow portion that forms an opening at said first end of body, said at least one interior hollow portion having a closed end such that water is prevented from traveling from said second end through said at least one interior hollow portion to said first end.

13. The method of claim 12 wherein said first end is adapted to be connected to another structure.

14. The method of claim 12 wherein said first end forms a finger joint.

15. The method of claim 12 further comprising:
cutting said first end to form a finger joint.

16. The method of claim 12 wherein said closed end of said at least one interior hollow portion is at said second end.

17. The method of claim 12 wherein said closed end of said at least one interior hollow portion is positioned intermediately between said first end and said second end.

18. The method of claim 12 wherein:
said body has lateral sides that extend between said first end and said second end; and
said at least one interior hollow portion extends in a direction parallel to said lateral sides.

19. The method of claim 12 wherein said body is comprised of a plurality of said interior hollow portions.

20. The method of claim 19 wherein said interior hollow portions occupy an entire cross-sectional area of said first end.

21. The method of claim 19 wherein said closed ends of said interior hollow portions are interconnected to form a substantially flat bottom surface at said second end.

22. The method of claim 19 wherein said body comprises:
lateral sides that extend between said first end and said second end; and
transverse members that extend between said lateral sides to form said interior hollow portions.

23. The method of claim 22 wherein said interior hollow portions extend in a direction parallel to said lateral sides.
